(19) United States
(12) Patent Application Publication
(10) Pub. No.: US 2016/0348576 A1
(43) Pub. Date: Dec. 1, 2016

(54) EXHAUST-GAS TURBOCHARGER

(71) Applicant: BORGWARNER INC., Auburn Hills, MI (US)

(72) Inventor: Dirk ELLENBERGER, Hochspeyer (DE)

(21) Appl. No.: 15/114,177

(22) PCT Filed: Jan. 28, 2015
(86) PCT No.: PCT/US2015/013302

§ 371 Date: Jul. 26, 2016

(30) Foreign Application Priority Data
Jan. 30, 2014 (DE) 10 2014 201 654.1

(51) Int. Cl. F02B 39/00; F01D 5/02; G01M 1/30; F02B 37/00

(52) U.S. Cl. CPC F02B 39/00; F02B 37/00; F01D 5/027; G01M 1/30; F05D 2220/40

(57) ABSTRACT

A method for balancing an exhaust-gas turbocharger rotor (14), comprising the steps of arranging a shoulder (12; 16; 20) rotationally conjointly on a shaft (10) of the rotor (14) and of removing at least a part of the material of the shoulder (12; 16; 20) in order to reduce the imbalance, and an exhaust-gas turbocharger rotor (14) having a shaft (10) on which a bearing arrangement (13) can be mounted, having a turbine wheel (6) on a first end (10a) of the shaft (10), and having a compressor wheel (2) on a second end (10b) of the shaft (10). A shoulder (12; 16; 20) is arranged on the shaft (10) between the compressor wheel (2) and the turbine wheel (6), which shoulder is connected rotationally conjointly to the shaft (10).

The invention relates to a method for balancing an exhaust-gas turbocharger rotor as per claim 1 and to an exhaust-gas turbocharger rotor as per the preamble of claim 10.

In the case of known methods for balancing exhaust-gas turbocharger rotors, use is made of two balancing planes, specifically at the compressor wheel and at the turbine wheel. With this method, the wobbling motion of the shaft of the exhaust-gas turbocharger rotor caused by imbalance can be reduced. Said methods however do not take into consideration imbalances which occur during the operation of the rotating turbocharger at supercritical rotational speeds. At such rotational speeds, the shaft of the exhaust-gas turbocharger rotor can no longer be regarded as a rigid body; rather, it acts more as a flexible body, and intensely rising acceleration levels are encountered. At the engine or in the vehicle, the rising acceleration levels have an effect on noise generation, or can even lead to failure of the bearing arrangement.

Balancing of the exhaust-gas turbocharger rotor at the available balancing planes, specifically at the compressor wheel and at the turbine wheel, is not possible under the conditions described above. In fact, with said balancing planes, the balancing of the exhaust-gas turbocharger cannot be improved any further, even though there is obviously, and demonstrably from the acceleration curve, still an imbalance in the vehicle.

It is therefore an object of the present invention to provide a method for balancing an exhaust-gas turbocharger rotor which eliminates the above disadvantages of the prior art. Furthermore, it is an object of the present invention to provide an exhaust-gas turbocharger rotor of the type specified in the preamble of claim 10, which affords the possibility of improved and precise balancing.

Said objects are achieved by means of the features of claims 1 and 10.

By contrast to the prior art, in which the balancing of an exhaust-gas turbocharger rotor is performed at two balancing planes, the present invention is based on the notion of providing a third balancing plane in order to attain improved balancing of an exhaust-gas turbocharger rotor. Owing to the third balancing plane, it is possible for imbalances that arise in the supercritical rotational speed range to be eliminated. In the present invention, the third balancing plane is realized by the arrangement of a shoulder rotationally conjointly on the shaft of the exhaust-gas turbocharger rotor.

The dependent claims contain advantageous developments of the invention. For example, as a shoulder, a spacer sleeve may be arranged on the shaft of the exhaust-gas turbocharger rotor. Instead of arranging a floating spacer sleeve between the radial bearing bushings, as is generally the case in the prior art, the spacer sleeve according to the present invention rotates together with the shaft of the exhaust-gas turbocharger rotor.

For the rotationally conjoint attachment of the spacer sleeve to the shaft of the exhaust-gas turbocharger rotor, the spacer sleeve may be cohesively connected to the shaft, for example welded, adhesively bonded or brazed to the shaft. It is self-evidently likewise possible for the connection of the spacer sleeve to the shaft to be realized by means of a screwing apparatus. It is likewise conceivable for the spacer sleeve to be fixed rotationally conjointly to the shaft by means of a positively locking connection, in particular a spline toothing or a tongue-and-groove connection. In the case of a tongue-and-groove connection, the tongue-and-groove connection should be formed on both sides in order to prevent additional structural imbalances. Thus, depending on the availability of the above methods and the requirements of the respective application, the spacer sleeve can be attached rotationally conjointly to the exhaust-gas turbocharger rotor in a simple manner.

With regard to its construction, the spacer sleeve may be of single-part or multi-part, in particular two-part form. Thus, the mounting of the spacer sleeve can be performed more easily depending on the application. Furthermore, the multi-part construction of the spacer sleeve may have the effect that the balancing of the exhaust-gas turbocharger rotor is made easier and can be performed in a more precise manner. Furthermore, a multi-part spacer sleeve offers the advantage that the spacer sleeve can be replaced, if necessary, inexpensively.

The spacer sleeve may preferably be arranged centrally on the shaft of the exhaust-gas turbocharger rotor, that is to say between the radial bearing bushings, which are used in the conventional manner, for the mounting of the shaft. The reason for this is that, in the supercritical rotational speed range, imbalance moments arise which excite and bend the rotor in the first eigenmode (bending mode). In this case, higher bending modes (for example second, third bending modes) of vibrations may also be induced. Owing to the central arrangement of the spacer sleeve on the shaft of the exhaust-gas turbocharger rotor, these bending modes can be balanced.

As a shoulder, use may also be made of a support element, which co-rotates with the shaft of the exhaust-gas turbocharger rotor, of an axial bearing, or a shaft collar. In this way, the balancing of an exhaust-gas turbocharger rotor is made possible with the existing components, without costs being incurred for additional parts and the corresponding installation work.

For the actual compensation of the imbalances, at least a part of the shoulder of one of the above-described embodiments can be subjected to material removal. Depending on the availability of manufacturing techniques and the desired accuracy, material can be removed by cutting, by means of a laser or in a spark erosion process.

Further details, advantages and features of the present invention can be found in the following description of exemplary embodiments with reference to the appended drawing, in which:

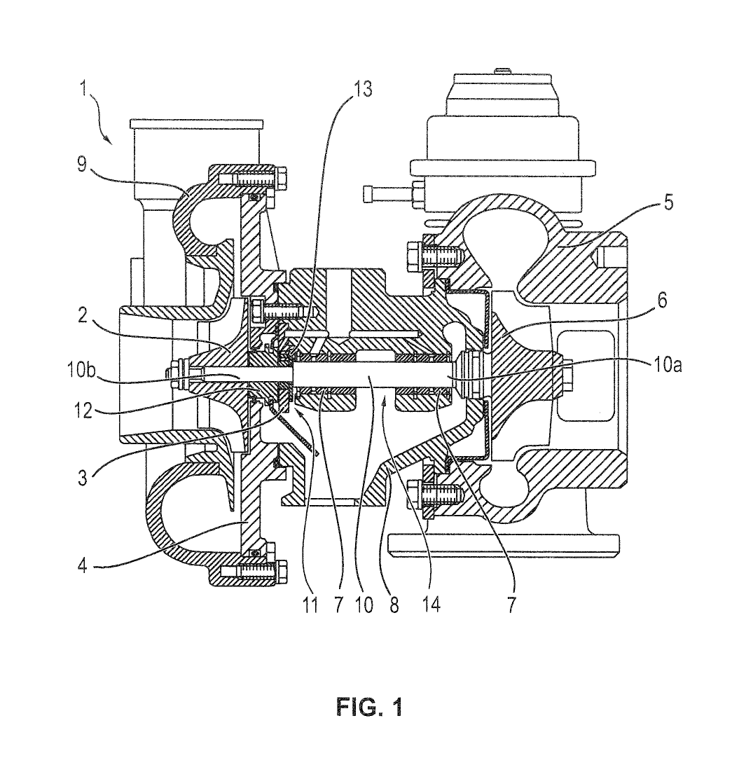

FIG. 1 shows a sectional illustration of an exhaust-gas turbocharger having a first embodiment of the exhaust-gas turbocharger rotor according to the invention as per the method according to the invention,

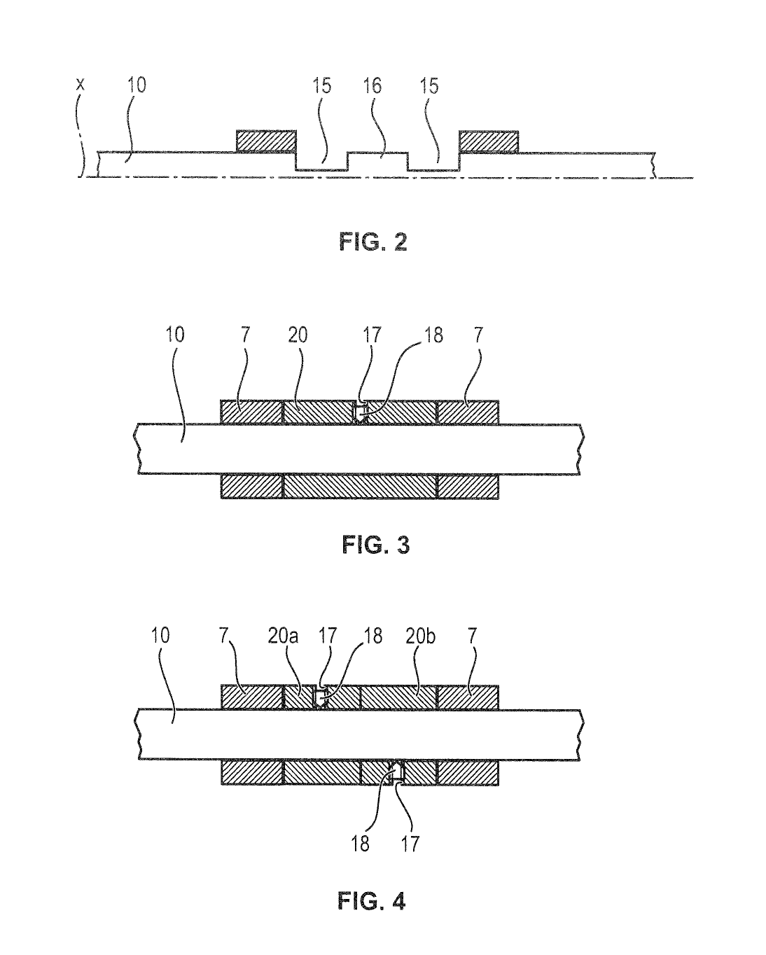

FIG. 2 shows a greatly simplified schematic illustration of a second embodiment of the exhaust-gas turbocharger rotor according to the invention, produced in accordance with the method according to the invention,

FIG. 3 shows a greatly simplified schematic illustration of a third embodiment of the exhaust-gas turbocharger rotor according to the invention, produced in accordance with the method according to the invention,

FIG. 4 shows a greatly simplified schematic illustration of a fourth embodiment of the exhaust-gas turbocharger rotor according to the invention, produced in accordance with the method according to the invention, and

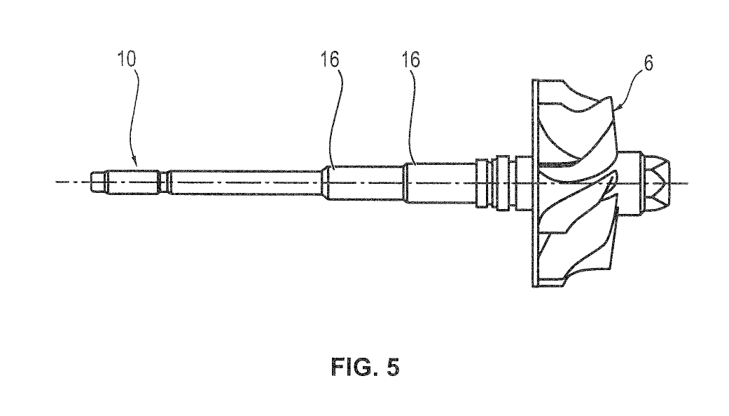

FIG. 5 shows a simplified, side-on illustration of a fifth embodiment of the exhaust-gas turbocharger rotor according to the invention, produced in accordance with the method according to the invention.

The same reference signs are used throughout the description to denote the same elements.

A first embodiment of the exhaust-gas turbocharger rotor 14 according to the invention and of the method according to the invention will be explained below on the basis of FIG. 1. An exhaust-gas turbocharger 1 is illustrated in FIG. 1. Said exhaust-gas turbocharger has a shaft 10, a turbine wheel 6 on a first end 10a of the shaft 10, and a compressor wheel 2 on a second end 10b of the shaft 10, these elements together forming the rotor 14. The compressor wheel 2 is arranged in a compressor housing 9 which is connected by way of a compressor rear wall 4 to a bearing housing 4. The bearing housing 4 comprises a bearing arrangement 13 which has two bearing bushings 7 spaced apart from one another axially and an axial bearing 3. The shaft 10 or the exhaust-gas turbocharger rotor 14 is arranged in the bearing housing 4 by means of the bearing arrangement 13. The turbine wheel 6 is arranged in a turbine housing 5.

To make it possible to balance the exhaust-gas turbocharger rotor 14, in the first step of the method according to the invention, use is made of a support element 12 of the axial bearing 3, on which balancing can be performed in the second step. The support element 12, which serves for supporting the axial bearing 3, is arranged, in a conventional manner, rotationally conjointly on the shaft 10. The balancing of the exhaust-gas turbocharger rotor 14 is performed by removing at least a part of the material of the support element 12. In this case, the material may preferably be removed by cutting, by means of a laser or in a spark erosion process. It is obvious here that the expression “cutting” is to be understood to mean any suitable mechanical machining for removing the material of the support element 12, such as for example milling, drilling, grinding, planing etc.

FIG. 2 is a greatly simplified schematic illustration of half of the shaft 10 of the exhaust-gas turbocharger rotor 14 as per a second embodiment of the method according to the invention. The shaft 10 is symmetrical with respect to the axis X. In this embodiment, in the first step, the shaft 10 is formed with a waisted shape, that is to say two recessed regions 15 of the shaft 10 have a diameter which is smaller than that of the shaft 10. Thus, a shaft collar 16 is formed between the recessed regions of 15, said shaft collar preferably having the same diameter as the shaft 10. In the second step of the method according to the invention, the material is removed from the shaft collar 16, by means of one of the methods mentioned above, in order to balance the exhaust-gas turbocharger rotor 14. The two recessed regions 15 and the shaft collar 16 are preferably formed between two radial bearing bushings (not illustrated) which are spaced apart from one another axially. This makes it possible in particular to permit balancing of the bending modes of the exhaust-gas turbocharger rotor 14.

FIG. 3 shows a greatly simplified schematic side view of half of the shaft 10 of the exhaust-gas turbocharger rotor 14 as per a third embodiment of the method according to the invention. In this case, in the first step, a spacer sleeve 20 is attached rotationally conjointly to the shaft 10 between two radial bearing bushings 7. The spacer sleeve 20 is in the form of a unipartite component and has a diameter which is at most equal to the outer diameter of the bearing bushings 7. Furthermore, the spacer sleeve has a threaded bore 17 into which a threaded pin 18 (grub screw) is screwed. The spacer sleeve 20 is connected rotationally conjointly to the shaft 10 by means of the threaded pin 18. For the rotationally conjoint attachment of the spacer sleeve 20 to the shaft 10, it is also possible to use other types of cohesive or positively locking connections, for example welded, adhesively bonded, or brazed connections, spline toothings or tongue-and-groove connections. The spacer sleeve is arranged between the bearing bushings 7 and is dimensioned such that the length of the spacer sleeve 20 corresponds to the gap between the bearing bushings 7. After the spacer sleeve 20 has been arranged on the shaft, in the second step of the method according to the invention, at least a part of the material of the spacer sleeve 20 is removed, and the exhaust-gas turbocharger rotor 14, in particular the bending modes thereof, is/are thus balanced.

As can be seen from FIG. 4, the arrangement of the shaft 10 as per a fourth embodiment of the method according to the invention generally corresponds to that of the shaft 10 illustrated in FIG. 3. Said fourth embodiment differs merely in that the spacer sleeve 20 is of two-part form. Each of the parts 20a and 20b of the spacer sleeve 20 has a threaded bore 17, into each of which a threaded pin 18 (grub screw) is screwed. The threaded bores 17 and the corresponding threaded pins 18 screwed therein are arranged at radially opposite points of the two parts 20a and 20b of the spacer sleeve 20, such that the attachment of the spacer sleeve 20 to the shaft 10 does not give rise to any additional imbalance.

FIG. 5 shows a side-on illustration of the shaft 10 of an exhaust-gas turbocharger rotor 14 as per a fifth embodiment of the method according to the invention. On the shaft 10, only the turbine 6 is shown. The shaft 10 has a multiplicity of shaft collars 16 (steps) at different points. Material is removed from the multiplicity of shaft collars 16 by means of one of the above methods in order to balance the exhaust-gas turbocharger rotor 14. It is also possible for only one shaft collar 10 to be provided.

To supplement the above written disclosure of the invention, reference is explicitly made to the illustrative representation in FIG. 1 to FIG. 5.

### LIST OF REFERENCE SIGNS

1 Exhaust-gas turbocharger
2 Compressor wheel
3 Axial bearing
4 Compressor rear wall
5 Turbine housing
6 Turbine wheel
7 Radial bearing bushing
8 Bearing housing
9 Compressor housing
10 Shaft
10a First end of the shaft
10b Second end of the shaft
12 Support element
13 Bearing arrangement
14 Rotor
15 Recessed region
16 Shaft collar
17 Threaded bore
18 Threaded pin (grub screw)
20 Spacer sleeve
20a First part of the spacer sleeve 20
20b Second part of the spacer sleeve 20

1. A method for balancing an exhaust-gas turbocharger rotor (14), comprising the steps:
arranging a shoulder (12; 16; 20) rotationally conjointly on a shaft (10) of the rotor (14); and
removing at least a part of the material of the shoulder (12; 16; 20) in order to reduce the imbalance.

2. The method for balancing an exhaust-gas turbocharger rotor (14) as claimed in claim 1, wherein, as a shoulder, a spacer sleeve (20) is attached rotationally conjointly to the shaft.

3. The method for balancing an exhaust-gas turbocharger rotor (14) as claimed in claim 2, wherein the spacer sleeve (20) is of single-part form.

4. The method for balancing an exhaust-gas turbocharger rotor (14) as claimed in claim 2, wherein the spacer sleeve (20) is of multi-part.

5. The method for balancing an exhaust-gas turbocharger rotor (14) as claimed in claim 2, wherein a welding, adhesive bonding, brazing or screwing apparatus is used for the rotationally conjoint attachment of the spacer sleeve (20).

6. The method for balancing an exhaust-gas turbocharger rotor (14) as claimed in claim 2, wherein the spacer sleeve (20) is fixed to the shaft by means of a positively locking connection.

7. The method for balancing an exhaust-gas turbocharger rotor (14) as claimed in claim 1, wherein a support element (12), which co-rotates with the shaft, of an axial bearing is used as a shoulder.

8. The method for balancing an exhaust-gas turbocharger rotor (14) as claimed in claim 1, wherein a shaft collar (16) is used as a shoulder.

9. The method for balancing an exhaust-gas turbocharger rotor (14) as claimed in claim 1, wherein the material of the shoulder (12; 16, 20) is removed by cutting, by means of a laser or in a spark erosion process.

10. An exhaust-gas turbocharger rotor (14), having
a shaft (10) on which a bearing arrangement (13) can be mounted;
a turbine wheel (6) on a first end (10a) of the shaft (10); and
a compressor wheel (2) on a second end (10b) of the shaft (10); wherein
a shoulder (12; 16; 20) is arranged on the shaft (10) between the compressor wheel (2) and the turbine wheel (6), which shoulder is connected rotationally conjointly to the shaft (10).

11. The exhaust-gas turbocharger rotor (14) as claimed in claim 10, wherein the shoulder (12; 16; 20) has an outer diameter which is at most equal to the outer diameter of the bearing arrangement (13).

12. The exhaust-gas turbocharger rotor (14) as claimed in claim 10, wherein the shoulder is a spacer sleeve (20).

13. The method for balancing an exhaust-gas turbocharger rotor (14) as claimed in claim 2, wherein the spacer sleeve (20) is of two-part form.

14. The method for balancing an exhaust-gas turbocharger rotor (14) as claimed in claim 2, wherein the spacer sleeve (20) is fixed to the shaft by means of a positively locking spline toothing or a positively locking tongue-and-groove connection on both sides.
